(19) United States
(12) Patent Application Publication
(10) Pub. No.: US 2013/0167415 A1
(43) Pub. Date: Jul. 4, 2013

(54) WINE LABEL

(71) Applicant: Fraser Patison Old, Milsons Point (AU)

(72) Inventor: Fraser Patison Old, Milsons Point (AU)

(73) Assignee: MYOORI PTY LTD, Milsons Point (AU)

(21) Appl. No.: 13/821,706

(22) PCT Filed: Sep. 23, 2011
(86) PCT No.: PCT/AU2011/001223

§ 371 Date: Mar. 8, 2013

(30) Foreign Application Priority Data
Sep. 27, 2010 (AU) 2010904342
Dec. 6, 2010 (AU) 2010905344

(51) Int. Cl. G09F 3/00

(52) U.S. Cl. CPC G09F 3/00
USPC 40/310

(57) ABSTRACT

The present invention discloses a wine label (4, 14, 24, 34, 44, 54, 64, 74, 84) suitable for a wine bottle 1 and having either a central substanitally rectangular area (8, 19) surrounded by at least two substantially rectangular tracks (6, 7) or a substanially rectangular bulls-eye formed by at least two looped tracks (6, 7). The tracks are of alternating colour impression. The overall shape of the label can be rectangular, trapezoid, diamond or curcus.

### FIELD OF THE INVENTION

The present invention relates to labels, and in particular, to the labels attached to wine bottles.

### BACKGROUND ART

Wine is traditionally sold in bottles which typically contain approximately 750 ml of wine and typically have a diameter of 70-75 mm. The wine market is extremely competitive with large numbers of producers which range from very large to very small organisations, each of which has many different types or varieties of wine for sale. In Australia most wine is sold via bottle shops or cellars many of which are parts of retail chains of considerable size and others of which are owner operated single establishments.

What all of these establishments seem to have in common is that an intending purchaser on entering the establishment is confronted with a bewildering array of wine bottles. The bottles themselves are of essentially a standard size and colour with there being only a small difference in shape, for example, between a bottle traditionally used for Riesling and a bottle traditionally used for red wine. The glass of most red wine bottles is dark, typically dark green or brown, which when filled with red wine gives the bottle a generally black or dark brown appearance. The glass of most white wine bottles is generally either pale green or clear, which when filled with white wine gives the bottle a pale yellow to medium green appearance.

The labels applied to wine bottles are generally rectangular being approximately 90-115 mm in axial length (which appears as the height of the label on the bottle) and approximately 60-100 mm in width. The surface of the bottle bearing the label being curved, the label appears to the purchaser to be more narrow than it actually is as the curvature of the bottle results in a foreshortening of the width of the label.

The labels themselves are of a bewildering variety being either generally white or light in colour with dark text and/or logo, or being generally dark in colour with generally light or white text and/or logo. This enables a contrast between the background of the label and the text to be achieved. That text indicates the brand, grape variety, year of vintage, volume of wine, alcoholic content, etc.

What is truly remarkable is that notwithstanding the plethora of brands, varieties and labels, there is no wine label which stands out from the bewildering crowd formed from the bottles arranged for sale in a bottle shop. A possible exception to this general statement is the Brown Bros. label which has an unusual shape, but is not particularly optically arresting.

### GENESIS OF THE INVENTION

The genesis of the present invention is a desire to enhance the self selecting properties of a bottle of wine by providing it with a label designed to increase the visual attractiveness of the bottle compared with wine bottles having conventional labels.

### SUMMARY OF THE INVENTION

In accordance with a first aspect of the present invention there is disclosed a wine label of generally rectangular configuration having a central substantially rectangular area surrounded by at least two substantially rectangular tracks, preferably of similar width, said central area and said tracks being of alternating colour impression and preferably substantially occupying the area of the label.

In accordance with a second aspect of the present invention there is disclosed a wine label of generally elongate configuration and comprising a substantially rectilinear bulls-eye formed by at least two looped tracks, preferably of similar width, and alternating colour impression, said bulls-eye preferably substantially filling the label.

In accordance with a third aspect of the present invention there is disclosed a bottle or container to which a label in accordance with either the first or second aspect is affixed.

In accordance with a fourth aspect of the present invention there is disclosed a method of enhancing self selection by a shopper of a first wine bottle displayed amongst a multiplicity of other wine bottles each of which displays a label of a competing brand, said method comprising the step of applying to said first wine bottle a label as defined in either of the two paragraphs above.

### BRIEF DESCRIPTION OF THE DRAWINGS

Several embodiments of the invention will now be described, with reference to the accompanying drawings in which:

FIG. 1 is a front perspective view of a white wine bottle having a wine label of a first embodiment adhered thereto;

FIG. 2 is a front elevational view of the wine label of FIG. 1 prior to its application to the bottle;

FIG. 3 is a view similar to FIG. 1 but of a wine label of a second embodiment;

FIG. 4 is a view similar to FIG. 2 but of the wine label of the second embodiment;

FIGS. 5 and 6 are views similar to FIGS. 3 and 4 but illustrating a trapezoid shaped label of a third embodiment;

FIGS. 7 and 8 are views similar to FIGS. 3 and 4 but illustrating a curcus shaped label of a fourth embodiment;

FIGS. 9 and 10 are views similar to FIGS. 4 and 3 but illustrating a half curcus shaped label of a fifth embodiment;

FIGS. 11 and 12 are views similar to FIGS. 3 and 4 but illustrating a non-concentric label of a sixth embodiment;

FIGS. 13 and 14 are views similar to FIGS. 3 and 4 but illustrating a skewed label of a seventh embodiment;

FIG. 15 is a perspective view of a bottle of an eighth embodiment illustrating a diamond or lozenge shaped label, and

FIG. 16 is a perspective view of a peanut butter jar.

### DETAILED DESCRIPTION

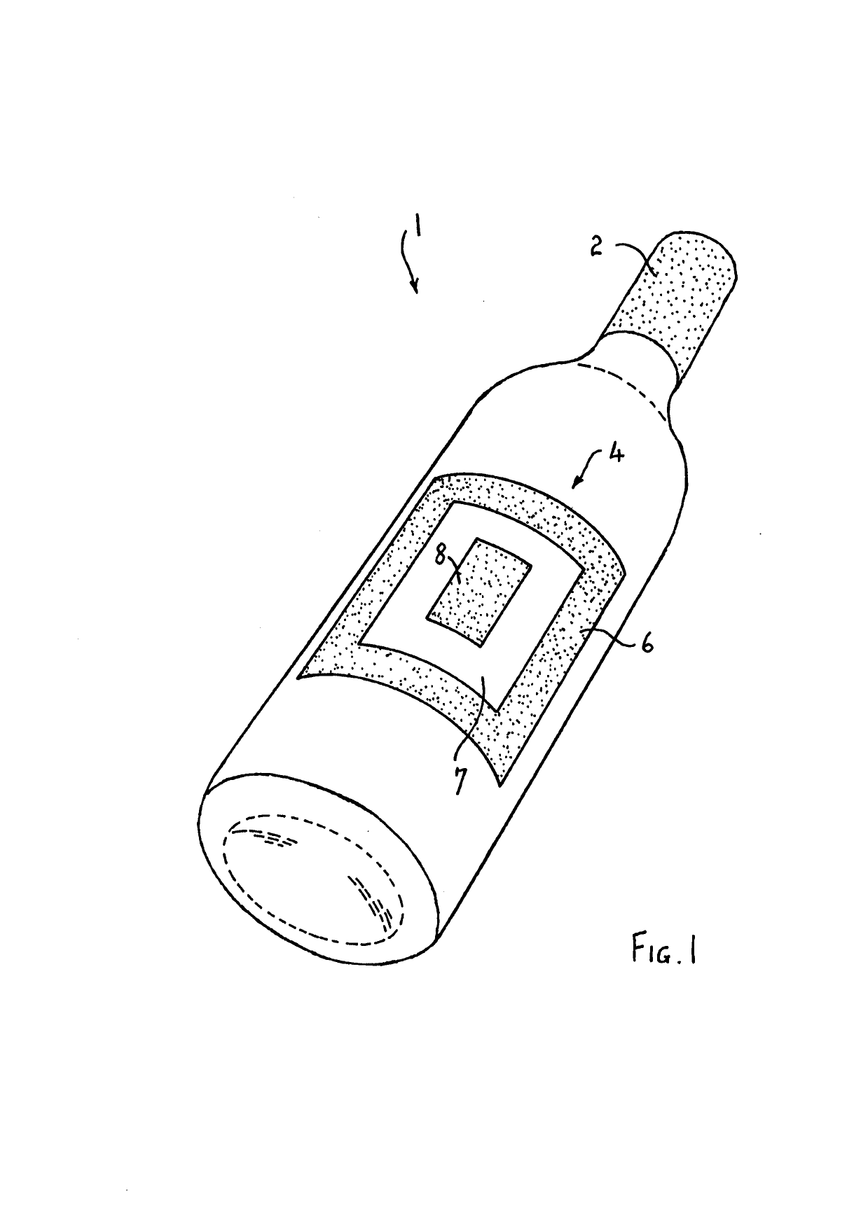

As seen in FIG. 1, a wine bottle 1 has a capsule 2 (in the event that a cork is used to close the bottle) or a screw cap 2 (in the event that a screw cap is used to close the bottle). In addition, the bottle 1 has a label 4 of generally rectangular configuration adhered to the front of the bottle.

There is normally another label on the rear of the bottle, however, that is not displayed for intending purchasers under normal circumstances and therefore is irrelevant to the present invention.

As seen in FIG. 1, the label 4 takes the form of a rectilinear bulls-eye which in the first embodiment has an outer rectangular path 6, an inner rectangular path 7 and a central rectangular zone 8. The paths 6 and 7 take the form of closed loops. As indicated by dots in FIG. 1, the outer rectangular path 6 and the central rectangular zone 8 are preferably of a dark colour (eg dark green or black) whereas the inner rectangular path 7 and the bottle itself (being a white wine bottle) are generally of a light colour (eg white or pale green). Thus an alternating colour impression is formed by the different colours of the adjacent zones. It will be seen that the paths are of similar width and that the bulls-eye fills the label, or substantially occupies the area of the label.

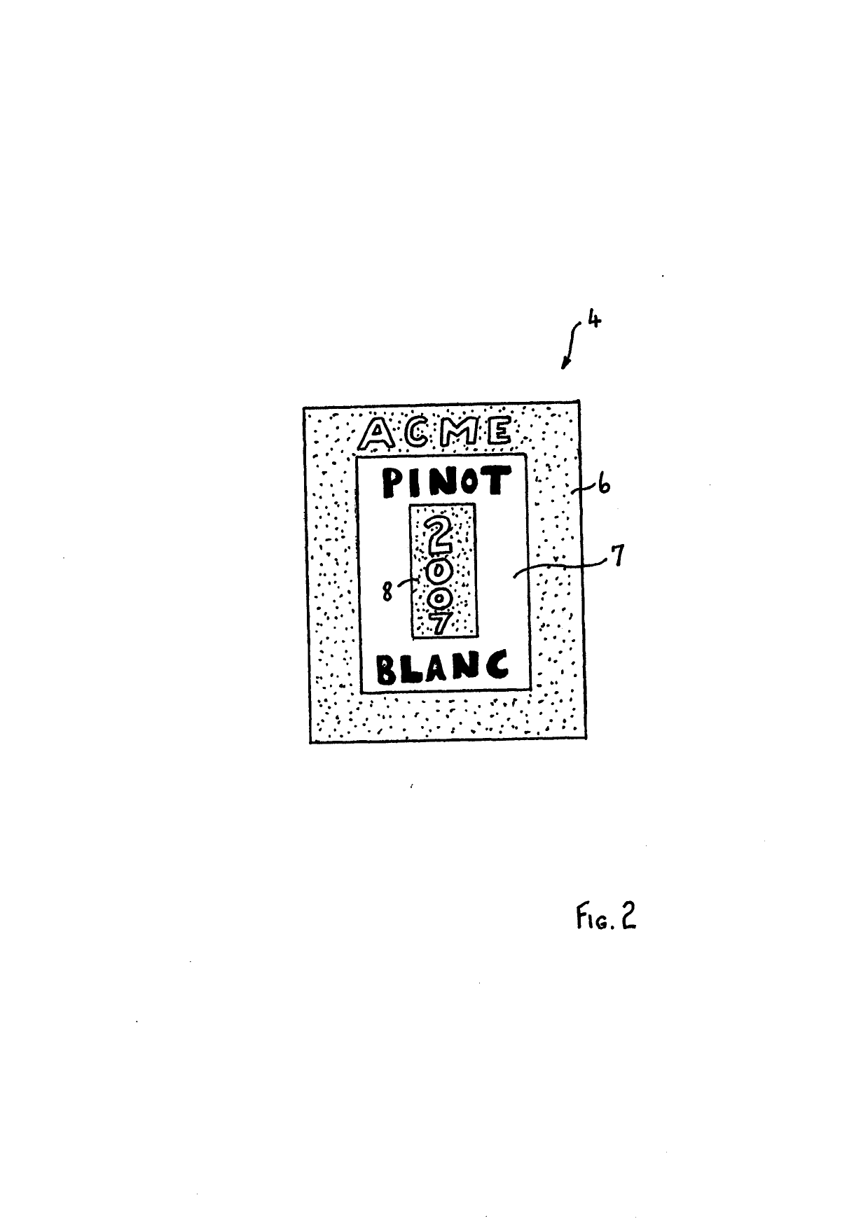

FIG. 2 shows the label 4 of FIG. 1 in more detail from which it will be seen that the brand ACME is displayed on the outer rectangular path 6 in white or light letters which contrast with the dark background of the outer rectangular path 6. The grape variety PINOT BLANC is displayed on the inner rectangular path 7 in preferably black letters which contrast with the white or light colour of the inner rectangular path 7. The central rectangular zone 8 displays the year of vintage 2007 again in white or light colours which contrast with the dark colouring of the central rectangular zone 8.

In FIG. 2 the widths of the paths 6, 7 are not merely similar but are preferably equal. The preferred width of the outer rectangular path 6 is approximately 15 mm and the preferred width of the inner rectangular path 7 is also approximately 15 mm whilst the central rectangular zone is preferably 20 m×40 m. This gives a label size of 100 mm from top to bottom and 80 m from left to right.

Preferably the text (ie the brand, grape variety, etc) is confined to a single path and does not cross over the junction between adjacent paths. This provides a mechanical effect which increases the legibility of the label 4.

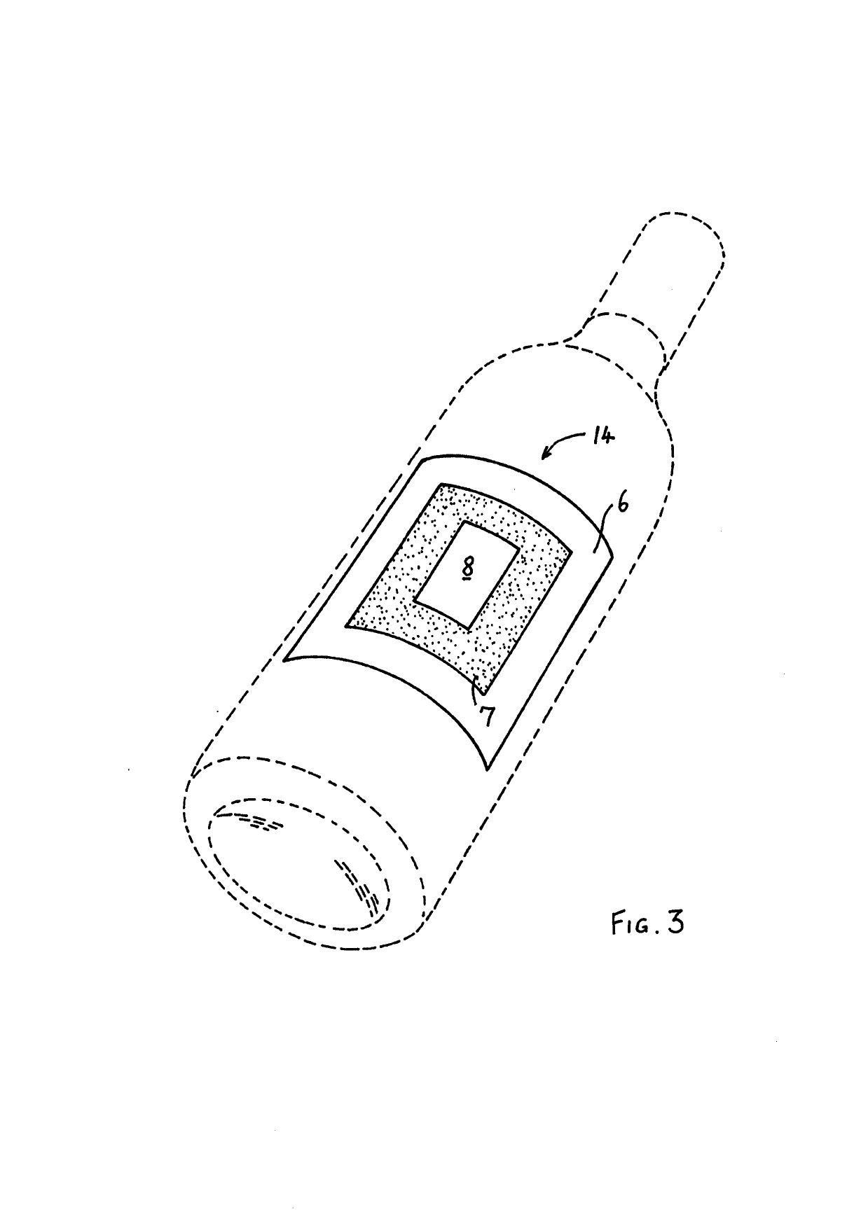

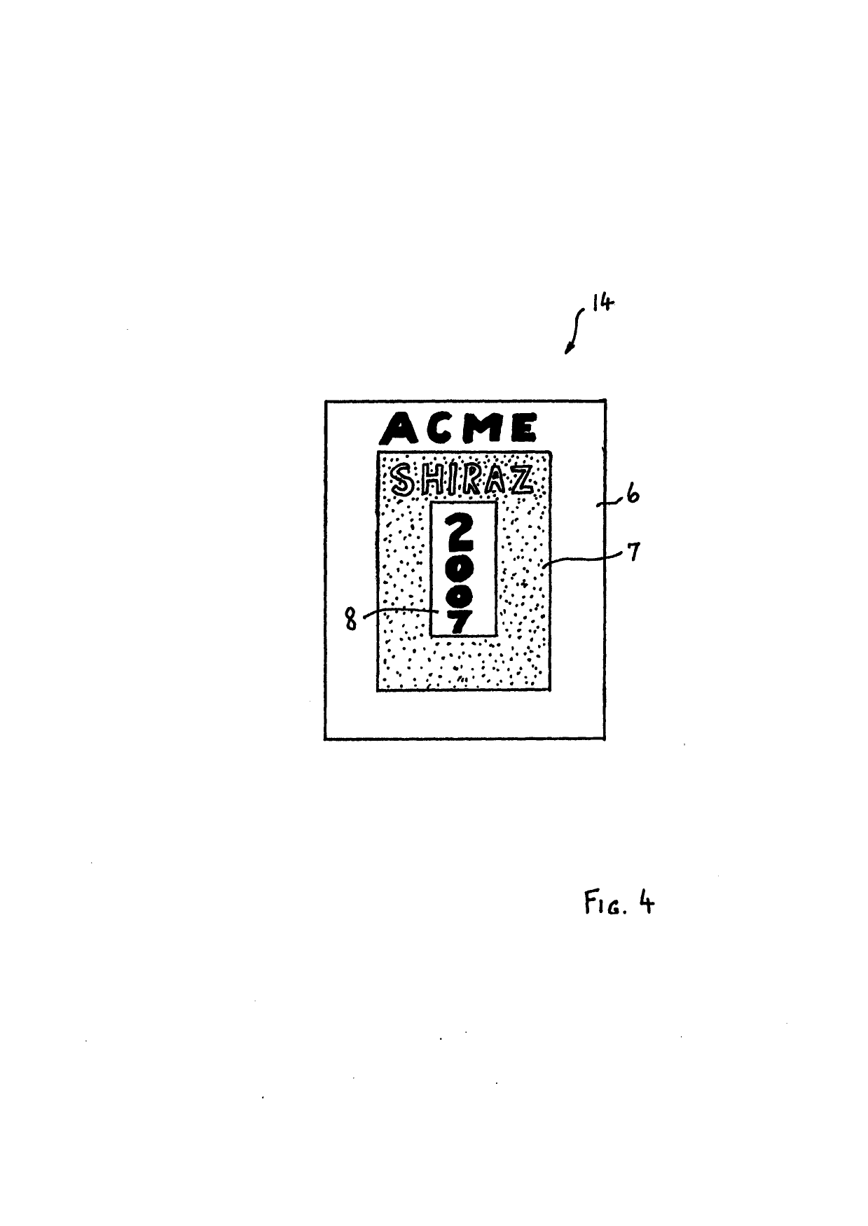

FIGS. 3 and 4 illustrate a wine label of a second embodiment intended for a red wine bottle. Since the colour of the bottle itself with the red wine in it will be quite dark, in accordance with the embodiment of FIGS. 3 and 4 the outer rectangular path 6 and the central rectangular zone 8 are white or light in colour (for example cream or yellow), and (as indicated by dots) the inner rectangular path 7 is dark in colour (for example black or dark red). Accordingly, in this embodiment the brand and year of vintage are indicated in black letters whereas the grape variety of SHIRAZ is indicated in light coloured letters, for example white.

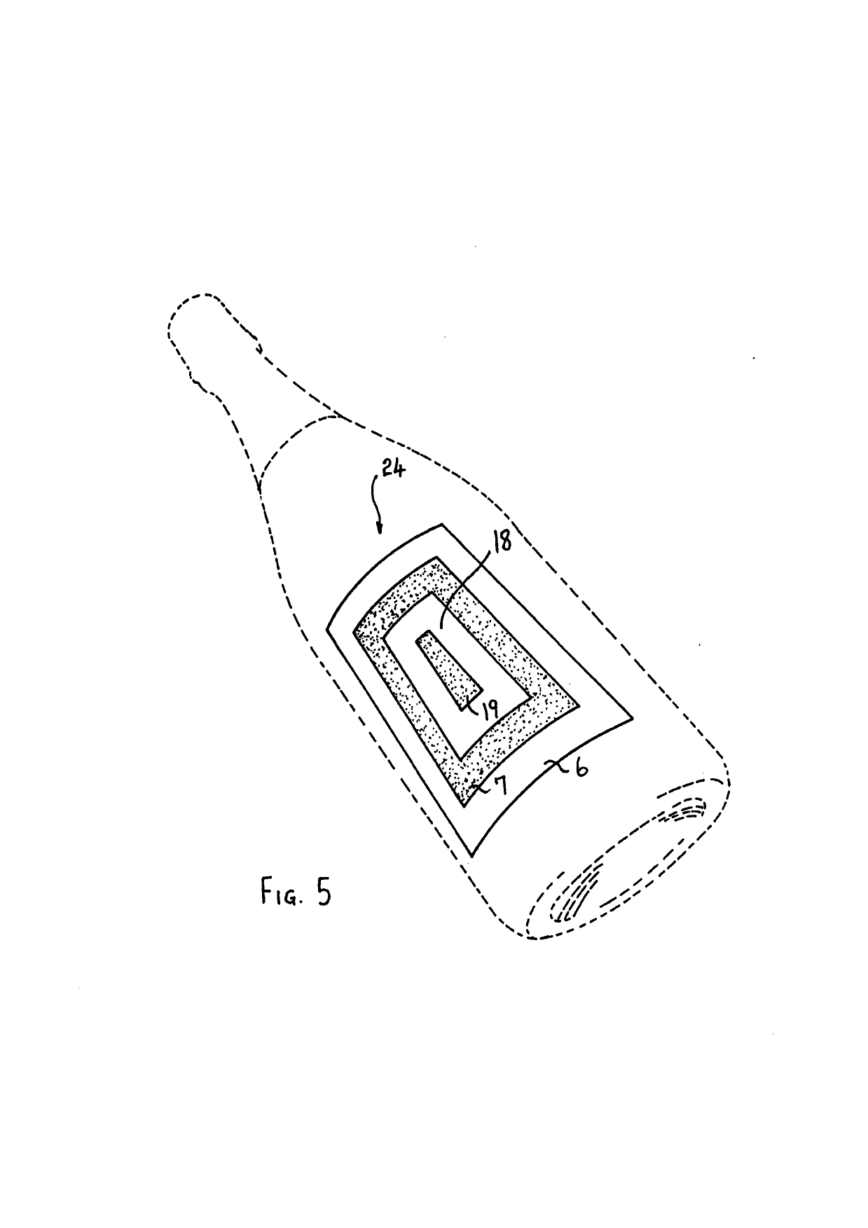

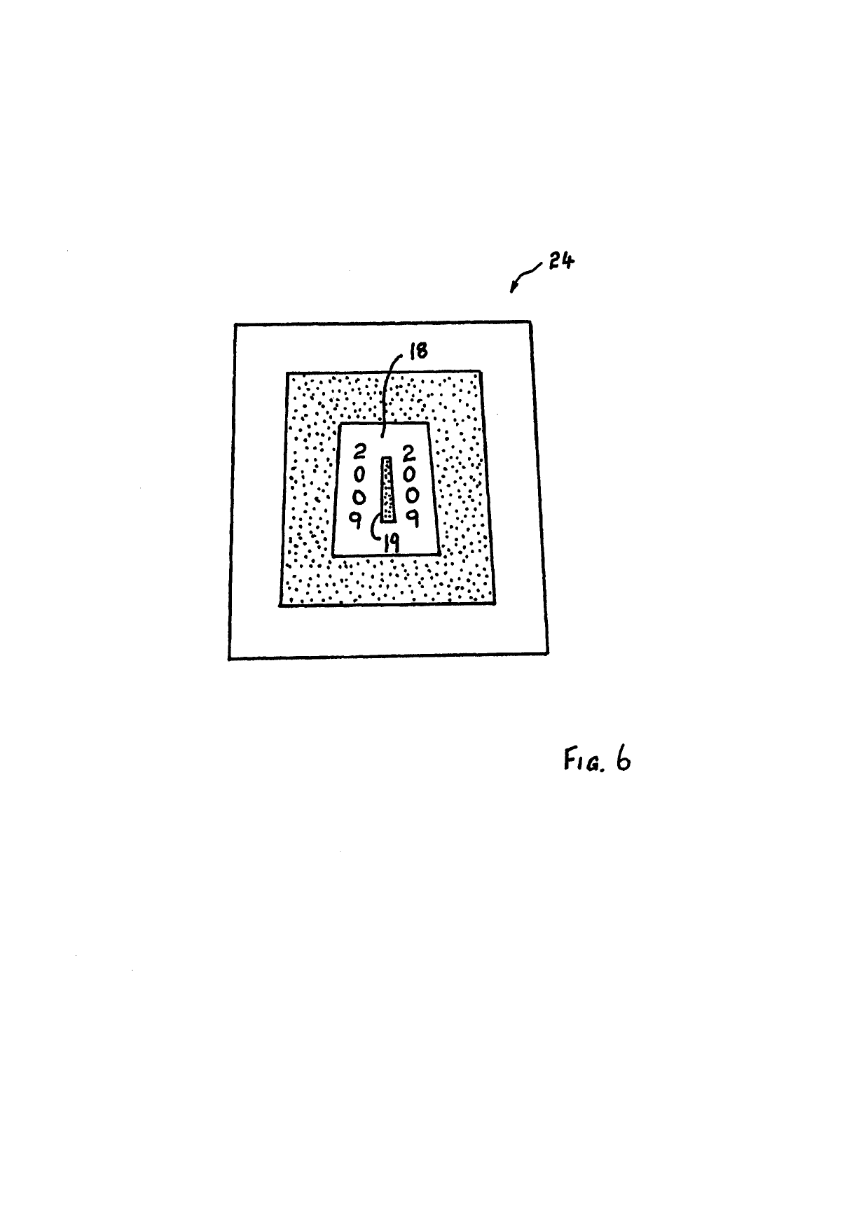

FIGS. 5 and 6 illustrate a trapezoid shaped label 24 in which the central zone 18 is centrally longitudinally divided by a truncated wedge 19 giving rise to three looped tracks 6, 7 and 18. The label 24 is illustrated in FIG. 5 affixed to a sparkling wine bottle (illustrated in broken lines to accentuate the label and indicate that the shape of the bottle is immaterial).

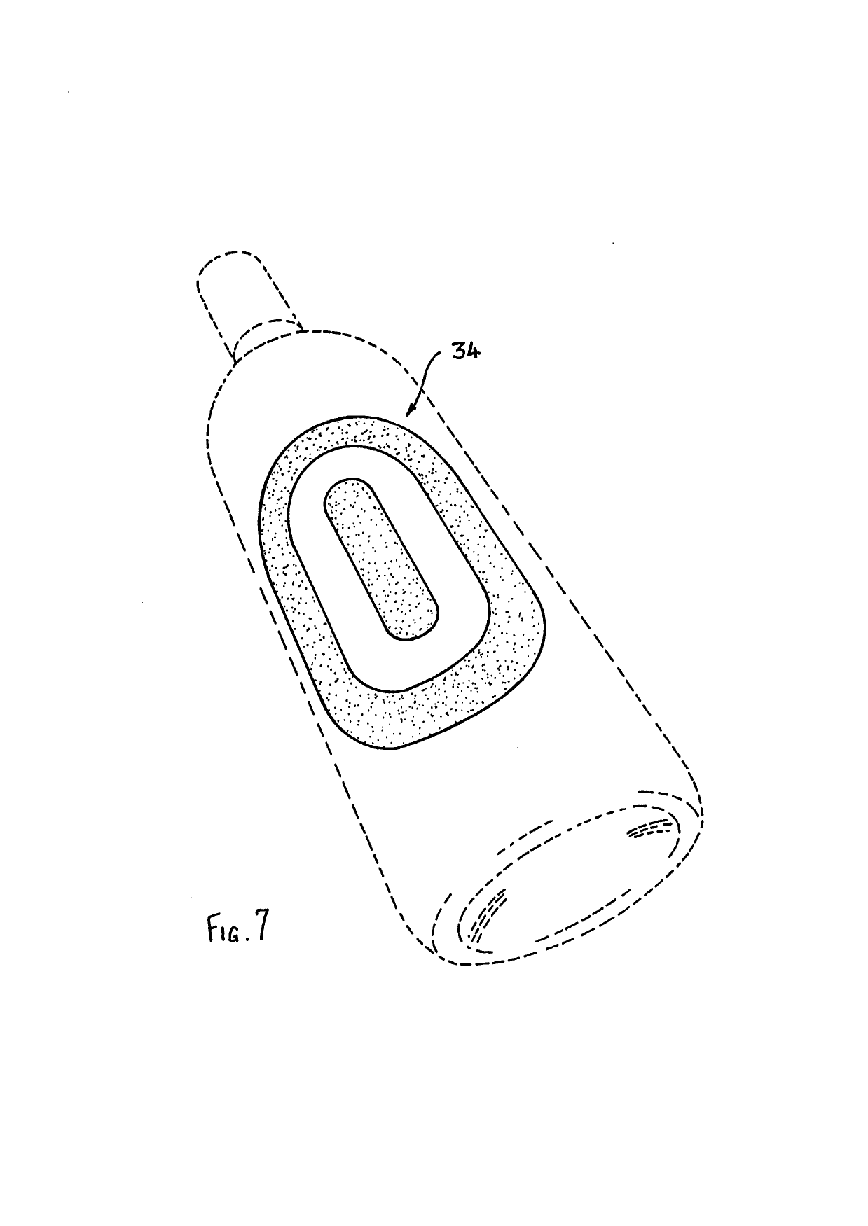

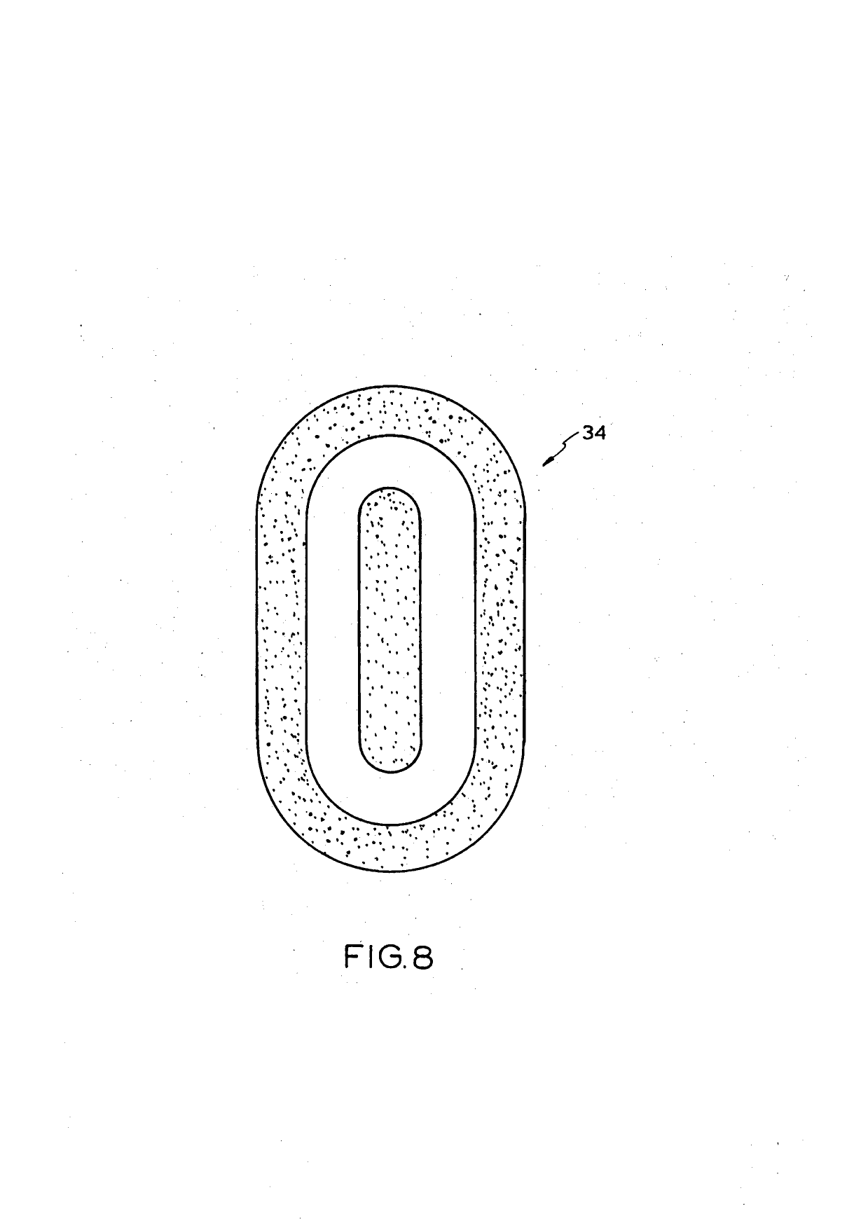

FIGS. 7 and 8 illustrate a race track or curcus shaped label 34 which is illustrated in “portrait” orientation but could be used in either the “portrait” or “landscape” orientation. The semicircular ends of the tracks give rise to the possibility of displaying text in an arcuate format.

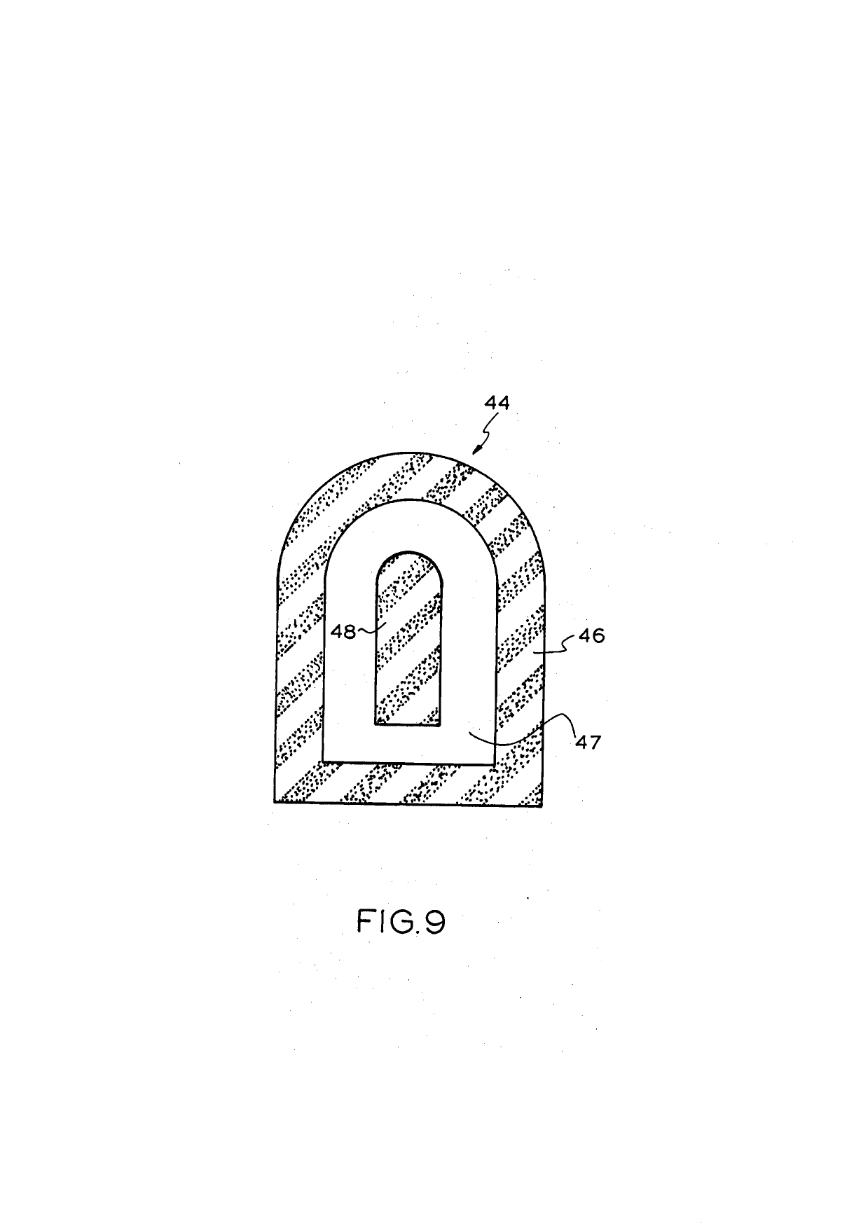

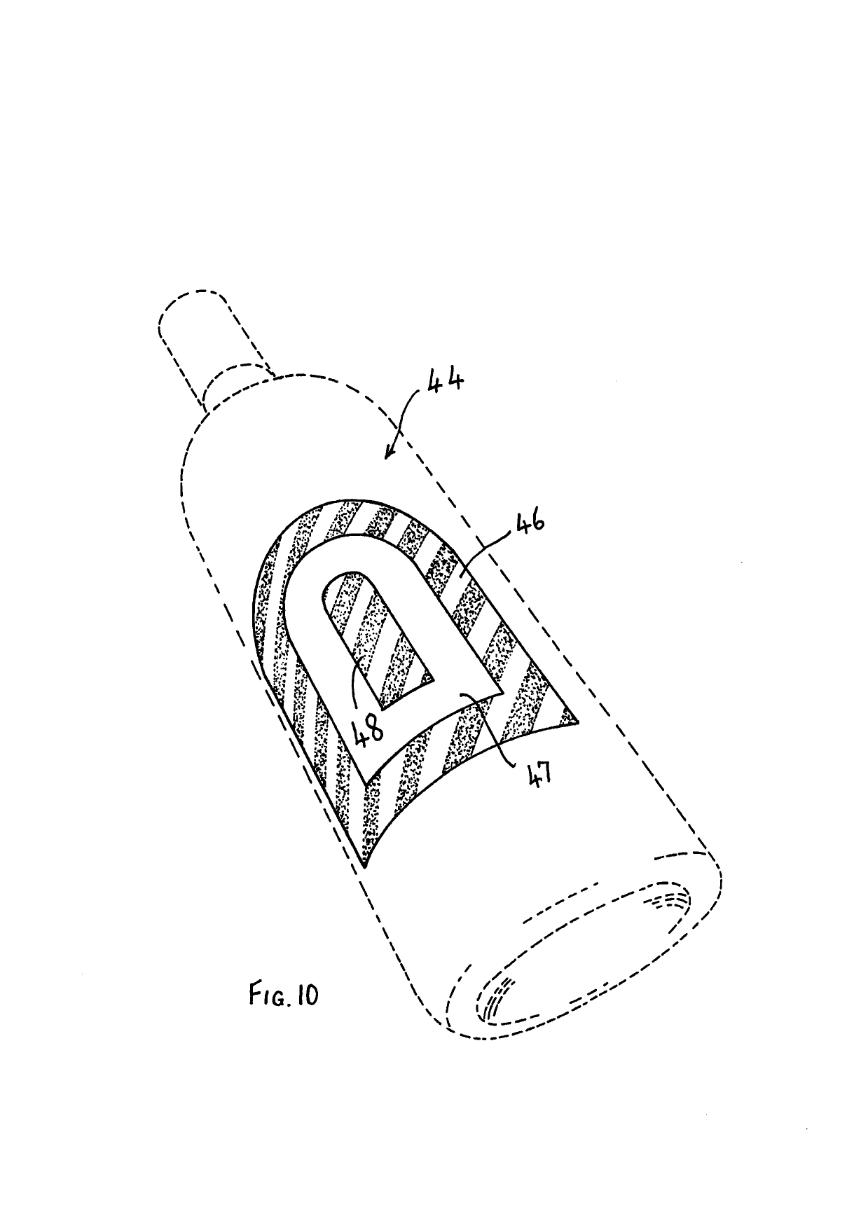

FIGS. 9 and 10 display a part semi-circular, part rectangular label 44 which combines elements of both the labels 4 of FIG. 2 and 34 of FIG. 7. In addition, the colour scheme indicated in FIG. 9 is particularly suitable for wines which are a blend of different grape varieties. Thus the outer track 46 and the inner zone 48 are coloured with two colours which preferably indicate the individual wines of the blend. For example, the track 46 and zone 48 can have red and yellow stripes indicating Shiraz and Cabernet Sauvignon respectively whist the inner track 47 can be a colour which contrasts with the colour of both stripes, for example white (or black).

Similarly, if the blend is a blend of Semillon grapes and Sauvignon Blanc grapes then the stripes can be yellow and blue respectively and the inner track 47 can again be white.

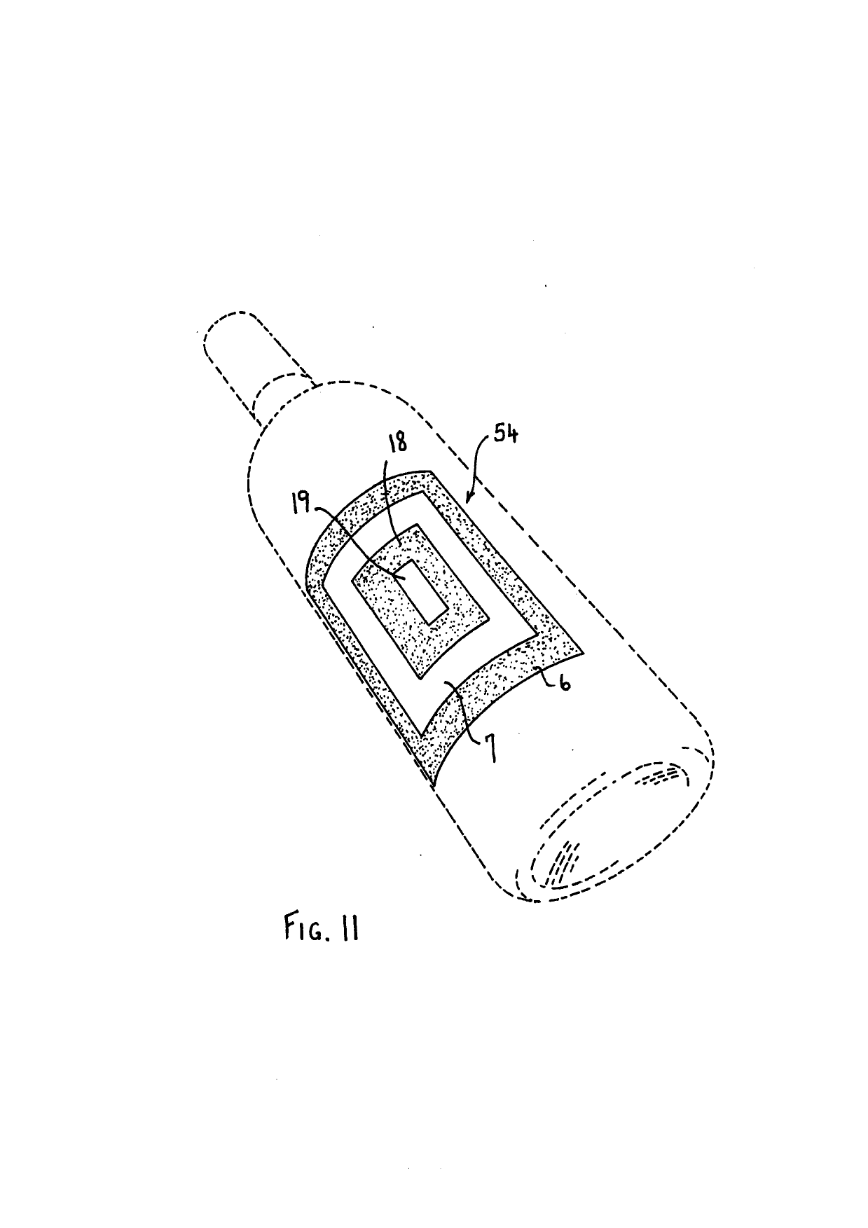

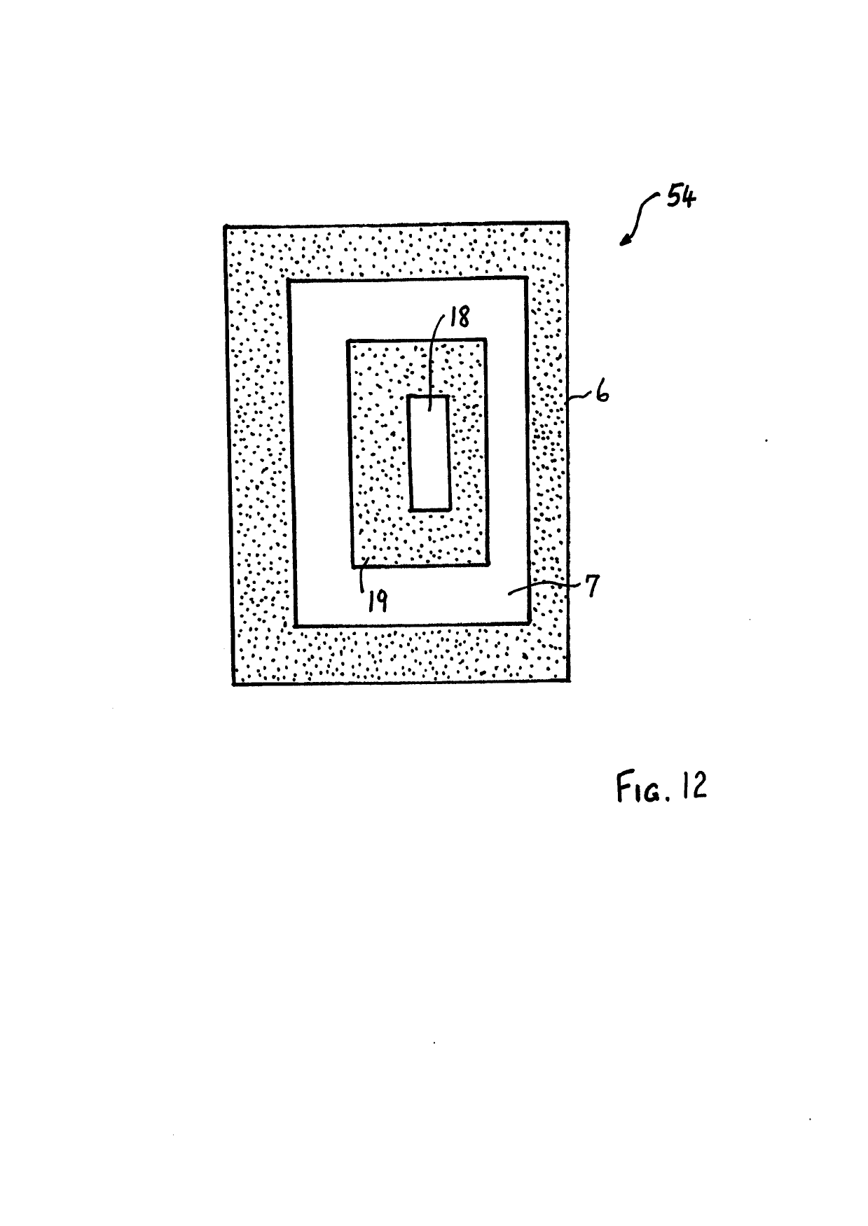

Turning now to FIGS. 11 and 12, it will be seen that a label 54 can be created observing the abovementioned requirements of loops or tracks, a rectilinear bulls-eye, and an alternating colour scheme but with an arrangement in which the tracks or loops are not concentric. That is, the central zone 19 and inner tracks 7 and 18 are displaced to the right as seen in FIGS. 11 and 12 relative to the outer track 6.

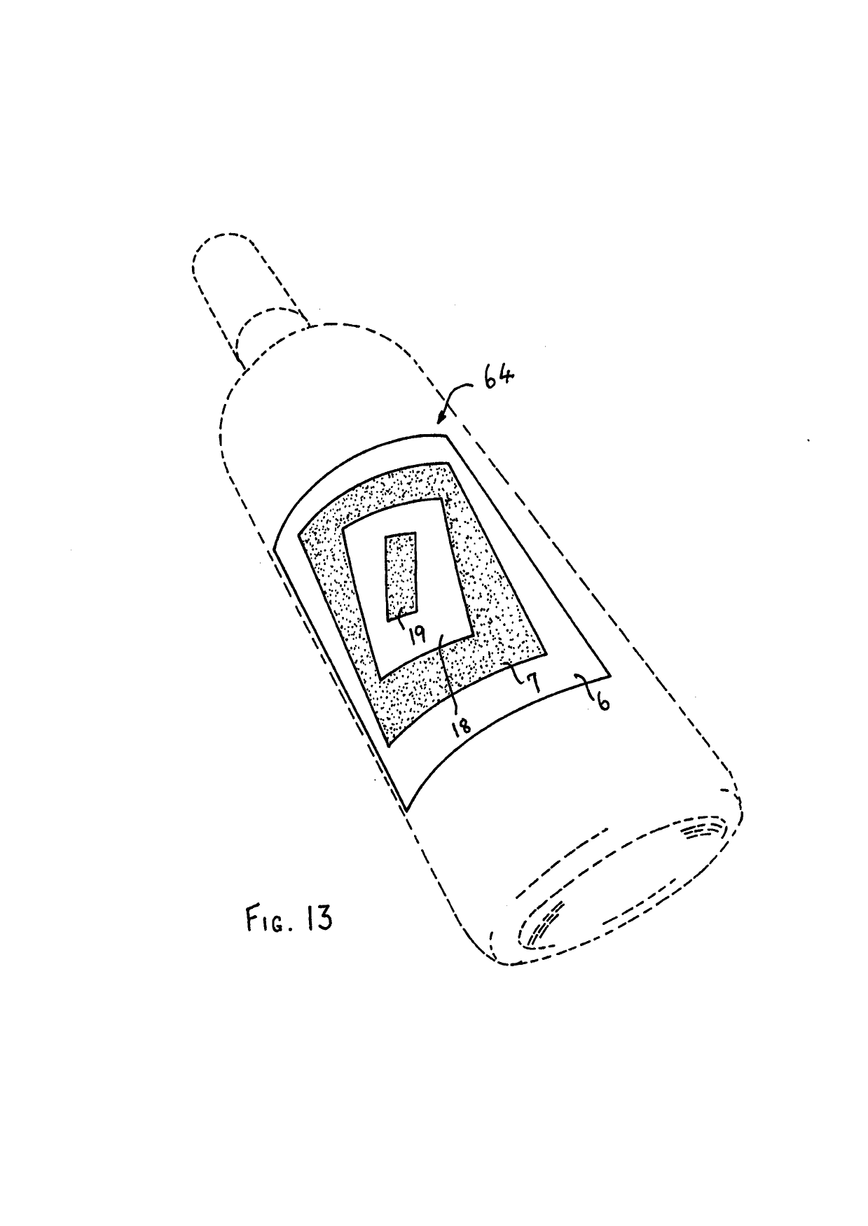

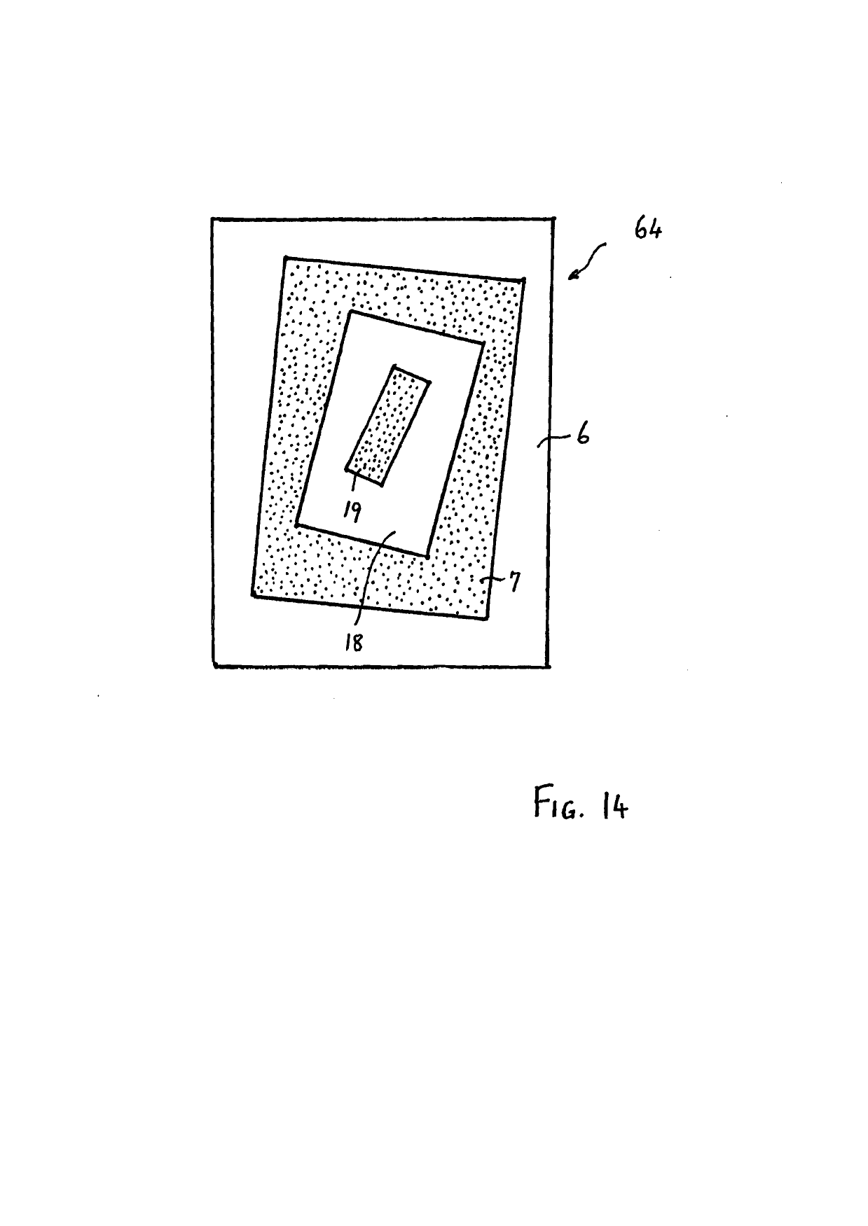

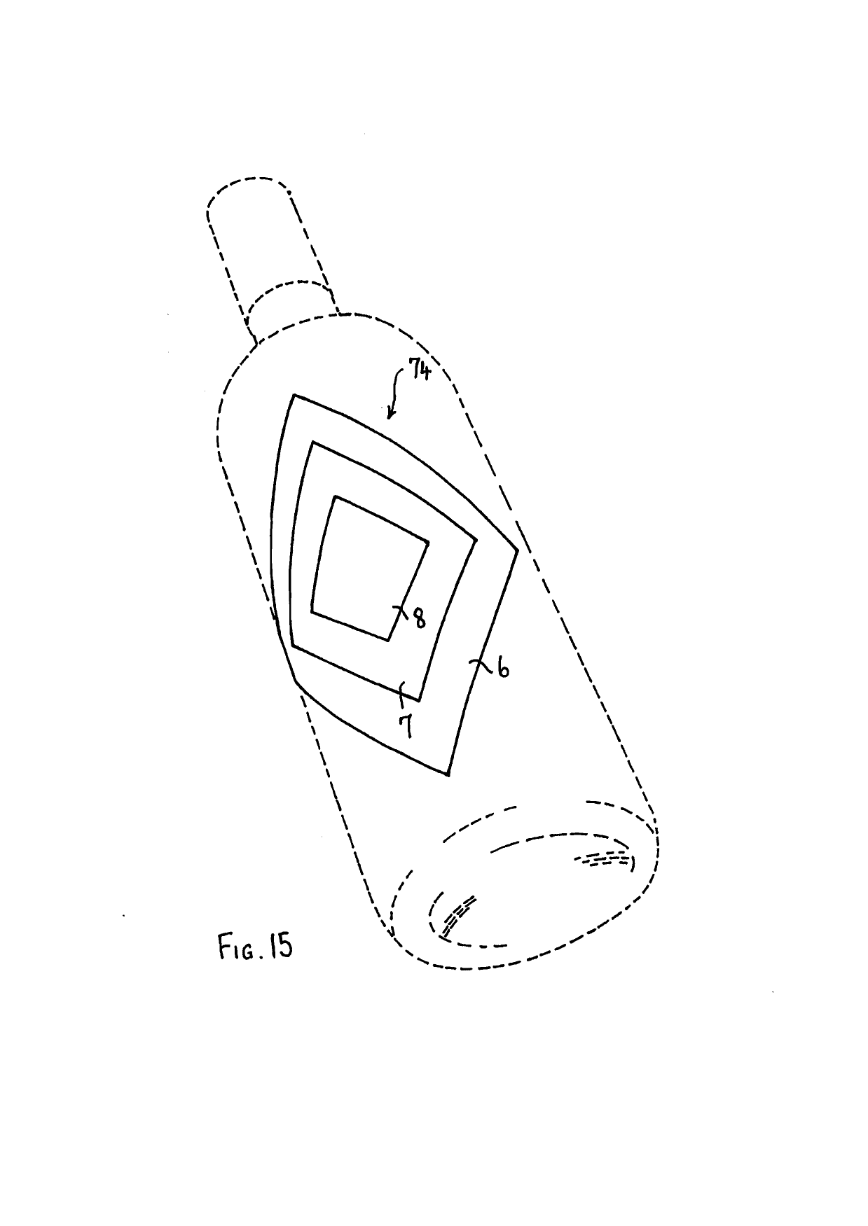

FIGS. 13 and 14 illustrate a still further label 64 in which each interior track 7, 18 or zone 19 is slightly skewed relative to the adjacent exterior track 6, 17 or 18 respectively. This creates a slightly inebriated characteristic for the label 64. FIG. 15 illustrates a label 74 of yet another embodiment in which the axis of the label is rotated through 45 degrees so as to give the label 74 a diamond or lozenge like appearance.

It will be apparent from the foregoing that the bottle 1 provided with such a label 4, 14, 24 , 34, 44,54, 64, or 74 once placed on the shelves of a bottle shop or wine cellar for display to the purchasing public will, because of the geometric properties of the paths 6 and 7 and the central zone 8, (or the paths 6, 7, 18 and zone 19) immediately attract the attention of intending purchasers and thereby assist in self selection of the bottle by the intending purchasers. These geometric properties have a mechanical purpose which gives rise to an optical effect which makes the label 14, 24, 34, 44,54, 64 or 74 (and hence the bottle carrying the label) visually arresting.

The wine labelling system according to preferred embodiments thereof unexpectedly and advantageously provides a contrast with other adjacent labelled wine bottles so as to increase the likelihood of receiving the conscious attention of the retail consumer.

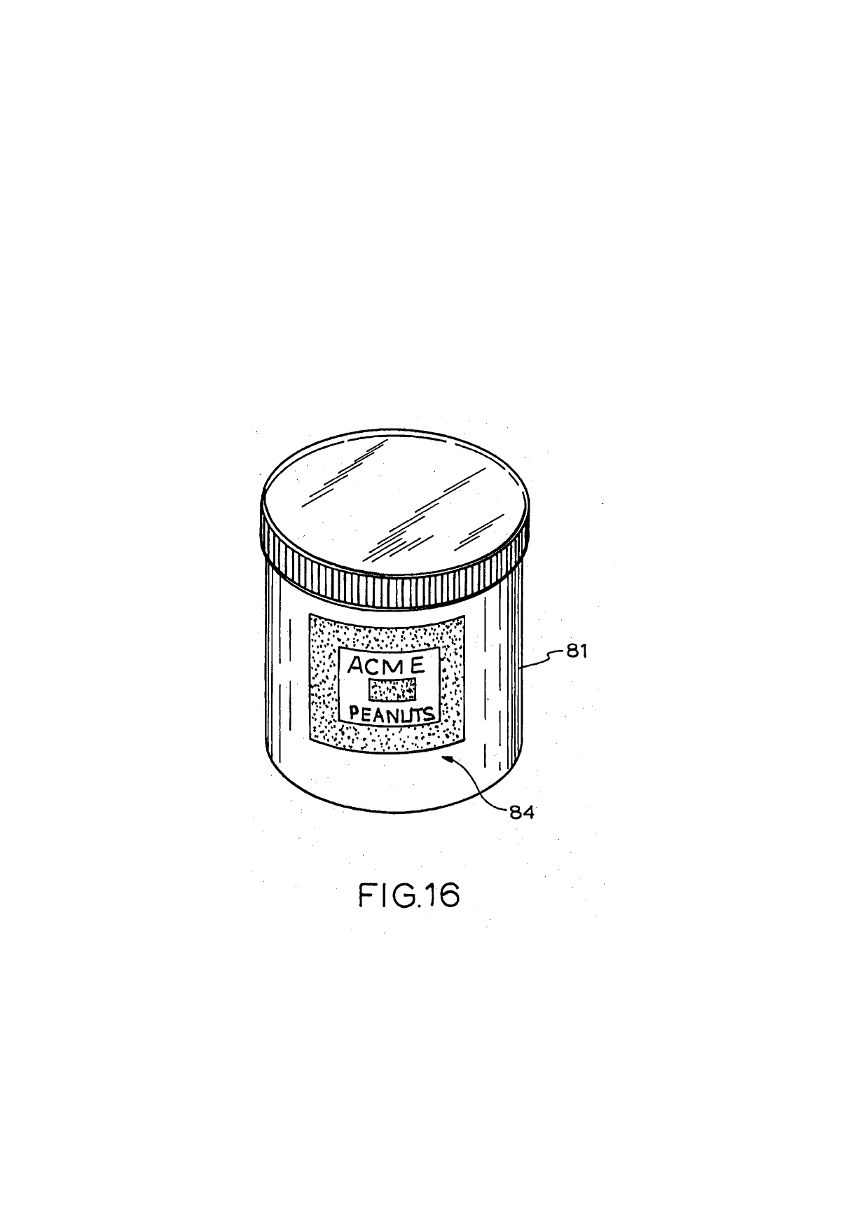

FIG. 16 illustrates a jar 81 of peanut butter (or peanut jelly) to which a label 84 similar to label 4 (but with “landscape” rather than “portrait” orientation) is applied. Again the sequence of tracks or loops has an alternating colour impression—for example the dotted regions can be black and the undotted yellow (eg sunflower yellow), or vice versa. Again, the text preferably does not cross over the boundary between adjacent regions.

The foregoing describes only some embodiments of the present invention and modifications, obvious to those skilled in the label manufacturing arts, can be made thereto without departing from the scope of the present invention. For example, the size, width, and number of the paths 6, 7 can be varied, thereby varying the overall size of the label 4, 14, 24, 34, 44, 54, 64, 74, or 84 but still providing the rectilinear bulls-eye appearance. This is particularly the case for 1 litre and 1.5 litre bottles. Similarly the bulls-eye need not be exactly as depicted in the drawings and could for example, be of parallelogram shape.

Furthermore, the label need not be fabricated from a sheet which is adhered to the bottle 1, instead the pattern of the label can be sprayed directly only the bottle 1. Under these circumstances every second track or loop can have the colour of the wine filled bottle, but this need not always be the case.

The term “comprising” (and its grammatical variations) as used herein is used in the inclusive sense of “including” or “having” and not in the exclusive sense of “consisting only of”.

1-14. (canceled)

15. A label visible from at least one side of a bottle, jar or like container, said label having a centrally located generally rectangular area surrounded by at least two closed loops each of which comprises a track of substantially uniform color impression with adjacent tracks being of alternating color impression, each of said tracks having indicia thereon, each of said tracks being sufficiently wide to enable said indicia to be of a size which is legible to a prospective purchaser viewing said label, and said central area and said tracks substantially filling the label.

16. The label as claimed in claim 1 wherein said label has a longitudinal axis and is adapted to be adhered to a wine bottle having a longitudinal axis with said label longitudinal axis being aligned with the longitudinal axis of a said wine bottle.

17. The label as claimed in claim 1 wherein said tracks are of substantially equal width.

18. The label as claimed in claim 1 wherein said tracks are substantially concentric.

19. The label as claimed in claim 1 wherein said tracks are not concentric.

20. A bottle having a label as claimed in claim 1.

21. A jar having a label as claimed in claim 1.
